(19) United States
(12) Patent Application Publication
(10) Pub. No.: US 2012/0305361 A1
(43) Pub. Date: Dec. 6, 2012

(54) CHANGE DISPENSER AND MONEY COLLECTING METHOD

(75) Inventor: Yuji Yasui, Shizuoka-ken (JP)

(73) Assignee: TOSHIBA TEC KABUSHIKI KAISHA, Tokyo (JP)

(21) Appl. No.: 13/473,793

(22) Filed: May 17, 2012

(30) Foreign Application Priority Data
May 31, 2011 (JP) 2011-122476

(51) Int. Cl. G07F 7/04

(52) U.S. Cl. 194/206

(57) ABSTRACT

A control unit of a change dispenser calculates the fraction amount less than unit of the par value of 5000-yen bill for the balance amount and the number of 1000-yen bill equivalent to the fraction amount, calculates each numbers of 1000-yen bill and 5000-yen bill needed to fill a balance amount obtained by subtracting the amount of 1000-yen bill based on the number calculated from the balance amount, according to 1000-yen bill and 5000-yen bill at a given ratio, determines the balance number of 1000-yen bill by adding the number of 1000-yen bill calculated to the number of 1000-yen bill calculated and determines the number of 5000-yen bill calculated as the balance number of 5000-yen bill.

### CROSS-REFERENCE TO RELATED APPLICATION

This application is based upon and claims the benefit of priority from Japanese Patent Application No. 2011-122476, filed May 31, 2011, the entire contents of which are incorporated herein by reference.

### FIELD

Embodiments described herein relate to a change dispenser for dispensing, for example, bills, as change and a money collecting method.

### BACKGROUND

There is developed a change dispenser for dispending bills as change, that is, the called a bill change dispenser. A bill storing unit for storing bills according to a denomination is configured inside of the casing having a bill depositing port and a bill dispensing port. Moreover, the bill change dispenser has the following functions: a change storing function of conveying-in the bills deposited to the bill depositing port to the casing; dividing the bills according to a denomination and storing to the bill storing unit; and a change dispensing function of conveying-out bills equal to the amount of the change from the bill storing unit according to the change data provided by a POS (Point of Sales) terminal and dispensing to the dispensing port.

Such a change dispenser usually has a function of balancing a given amount of bills in the storing unit and collecting the balance bills. This function is called a collect balance function and the given amount is called a balance amount. Through this function is carried out every after closing a shop, may leave a given amount of bills in the storing unit as the change fund to be used in the next business day and collect the balance amount of the bills as the sales in a day. However, how many numbers of bills of each denomination should be left is determined depending upon the change use condition of each shop, but not determined uniformly.

### BRIEF DESCRIPTION OF THE DRAWINGS

FIG. 1 is an external perspective view of a bill change dispenser according to an embodiment;

FIG. 2 is a block diagram showing the main components of the bill change dispenser;

FIG. 3 is a diagram of the primary storage area formed in the storage unit of the bill change dispenser;

FIG. 4 is a flowchart showing the process flow carried out by the control unit of the bill change dispenser according to a money collecting program;

FIG. 5 is a flow chart showing the specific flow of the process for determining a balance number carried out in the Act ST7 shown in FIG. 4;

FIG. 6 is a flow chart showing the specific flow of the process for correcting a actual-balance carried out in the Act ST34 shown in FIG. 5.

### DETAILED DESCRIPTION

According to one embodiment, a change dispenser comprises a money collecting unit configured to balance a given balance amount of money as a reserved change fund in a money storing unit in which a first money having the minimum par value and a second money greater in par value than the first money are stored and to collect the rest money from the money storing unit. The money collecting unit comprises a first unit configured to, for the balance amount, calculate the fraction amount less than unit of the par value of the second money and the number of the first money equivalent to the fraction amount; a second unit configured to calculate each numbers of the first money and second money needed to fill a balance amount obtained by subtracting the amount of the first money based on the number calculated by the first unit from the balance amount, according to the first money and the second money at a given ratio; a third unit configured to determine the balance number of the first moneys by adding the number of the first money calculated by the second unit to the number of the first money calculated by the first unit; and a fourth unit configured to determine the number of the second money calculated by the second unit as the balance number of the second money.

Embodiment of the change dispenser is described below with reference to accompanying drawings. Moreover, the embodiments are described based on the application of a bill change dispenser 1 which processes Japanese Yen of three kinds of bills: 1000-yen bill (a first bill) as the minimal par value, 10000-yen bill (a third bill) as the maximum par value and 5000-yen bill (a second bill) as the intermediate par value.

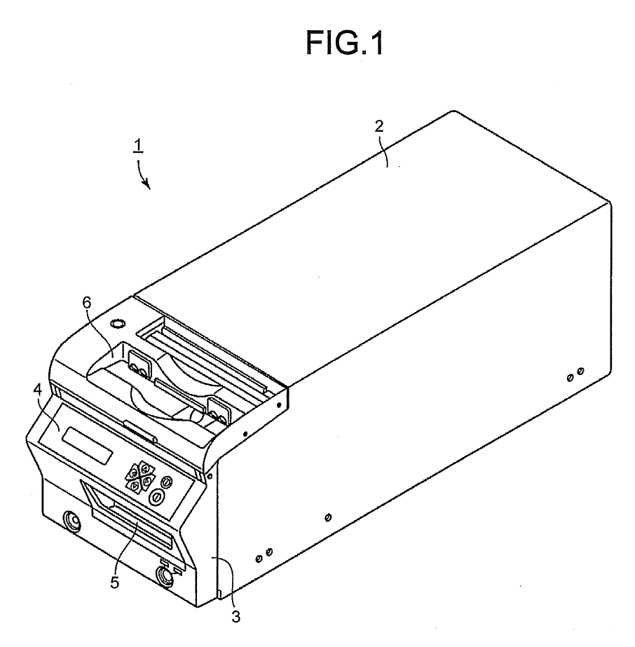

FIG. 1 is an external perspective view of the bill change dispenser 1. The bill change dispenser 1 comprises a box-shaped casing 2 having an opened front side, and a main body 3 that is configured in the casing 2 and may be drawn out from the opened side of the casing 2. An operating panel 4 and a bill dispensing port 5 are configured on the front side of the main body 3, a bill depositing port 6 is formed on the upper side of the main body 3 connected with the front side, and when the main body 3 is installed in the casing 2, the opened side of the casing 2 is blocked by the upper side and the upper side connected with the front side.

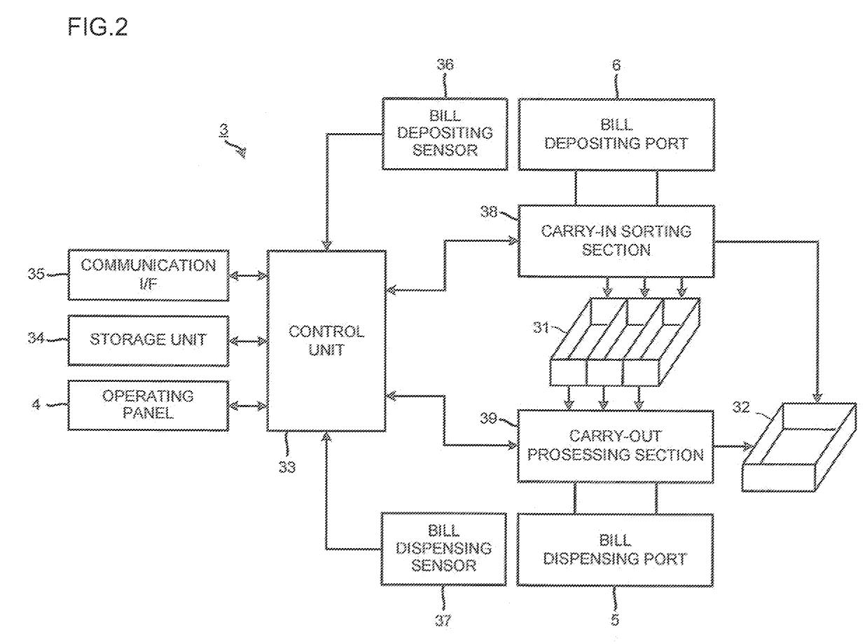

FIG. 2 is a block diagram showing the main components of the main body 3. The main body 3 comprises a bill storing repository (bill storing unit) 31 that may store according to denomination of tree kinds of bills and a bill collecting repository 32. The bill storing repository 31 and the bill collecting repository 32 are both stored in the casing 2 when the main body 3 is installed in the casing 2. However, the bill collecting repository 32 can be drawn out from the front side of the main body 3 even when the main body 3 is installed in the casing 2.

The main body 3 further comprises a control unit 33, a storage unit 34, a communication interface 35, a bill depositing sensor 36, a bill dispensing sensor 37, a carry-in sorting section 38 and a carry-out processing section 39.

The control unit 33, the main body of which is the CPU (Central Processing Unit) serving as the central system of a computer, controls each other component according to programs so as to achieve the functions of the bill change dispenser 1 such as change storing function and change dispensing function. The programs are stored in the storage unit 34. Moreover, the storage unit 34 has a storage area for storing various kinds of data. The communication interface 35 is responsible for the data communication between the control unit of a POS terminal connected by a wired or wireless communication unit and the control unit 33.

The bill depositing sensor 36 detects the bill fed from the bill depositing port 6. The control unit 33 activates the carry-in sorting section 38 (change storing function) when bills are detected by the bill depositing sensor 36. The carry-in sorting section 38 conveys the bills input from the bill depositing port 6 and selects the bills according to par value, and then stores the selected bills in the bill storing repository 31 or the bill collecting repository 32 according to par value. That is, the carry-in sorting section 38 stores 1000-yen bills, 5000-yen bills and 10000-yen bills in the bill storing repository 31 or bills of other par values such as 2000-yen bills in the bill collecting repository 32.

After receiving a change amount from the POS terminal through the communication interface 35, the control unit 33 activates the carry-out processing section 39 (change dispensing function). The carry-out processing section 39 outputs the change amount of bills from the bill storing repository 31 and discharges the bills from the bill dispensing port 5. The bill dispensing sensor 37 detects the bills discharged from the bill dispensing port 5.

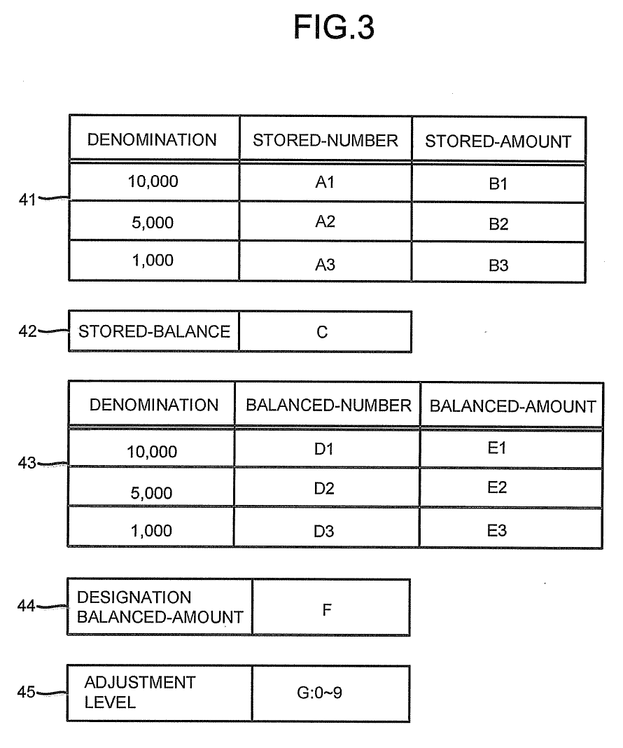

FIG. 3 shows a primary storage area formed in the storage unit 34. As shown in FIG. 3, in the storage unit 34 of the bill change dispenser 1, there is an storing data table 41 in which the amount of bills of each par value is stored, a stored balance storage 42, a balance data table 43 in which the balance amount of bills of each par value is stored, a designation balance amount storage 44 and an adjustment grade storage 45.

The numbers A1, A2 and A3 (A1 being the number of the 10000-yen bills stored, A2 being the number of the 5000-yen bills stored, A3 being the number of the 1000-yen bills stored) of the bills stored in the bill storing repository 3 and the amounts B1, B2 and 33 of the 10000-yen bills, the 5000-yen bills and the 1000-yen bills are stored in the storing data table 41 according to par value. The total amount C of all the bills stored in the bill storing repository 31 is stored in the stored balance storage 42.

The carry-in sorting section 38 provides the par values of the selected bills to the control unit 33. The carry-out processing section 39 provides the par values of the bills discharged from the bill storing repository 31 to the control unit 33. Based on the par value information, the control unit 33 updates the numbers A1, A2 and A3 and storing amounts B1, B2 and B3 stored in the storing data table 41 and the total amount C stored in the stored balance storage 42.

The numbers (D1 being the number of the reserved 10000-yen bills, D2 being the number of the reserved 5000-yen bills, D3 being the number of the reserved 1000-yen bills) of the bills reserved by the balance and collecting function that will be described later as a reserved change fund and corresponding amounts (E1 being the amount of the reserved 10000-yen bills, E2 being the amount of the reserved 5000-yen bills, E3 being the amount of the reserved 1000-yen bills) are stored in the balance data table 43 according to par value. The designation balance amount storage 44 stores a balance amount F as a reserved change fund. The adjustment grade storage 45 stores an adjustment grade G (G being an integer ranged from 0-9), which represents the ratio of the 5000-yen bills and 1000-yen bills reserved as a change fund. That is, the ratio of 5000-yen bills to 1000-yen bills is 0:10 when the adjustment grade G is 0, 1:9 when the adjustment grade G is 1, and 2:8 when the adjustment grade G is 2. Adjustment grades 3-9 mean hereinafter the same ratio, for example, the ratio of 5000-yen bills to 1000-yen bills is 9:1 when the adjustment grade is 9.

The balance and collecting function actualizes the balance of the balance amount F of bills in the bill storing repository 31 and the discharge of the rest bills from the bill storing repository 31 to the bill collecting repository 32 by using the carry-out processing section 39. This function is implemented when a balance and collecting instruction is given to carryout a business accounting operation using the POS terminal after the shop is closed. A balance amount and an adjustment grade are optionally contained in the balance and collecting instruction. That is, in the POS terminal, if at least one of a balance amount and an adjustment grade is designation before the business accounting is carried out, then the designation data is contained in the balance and collecting instruction.

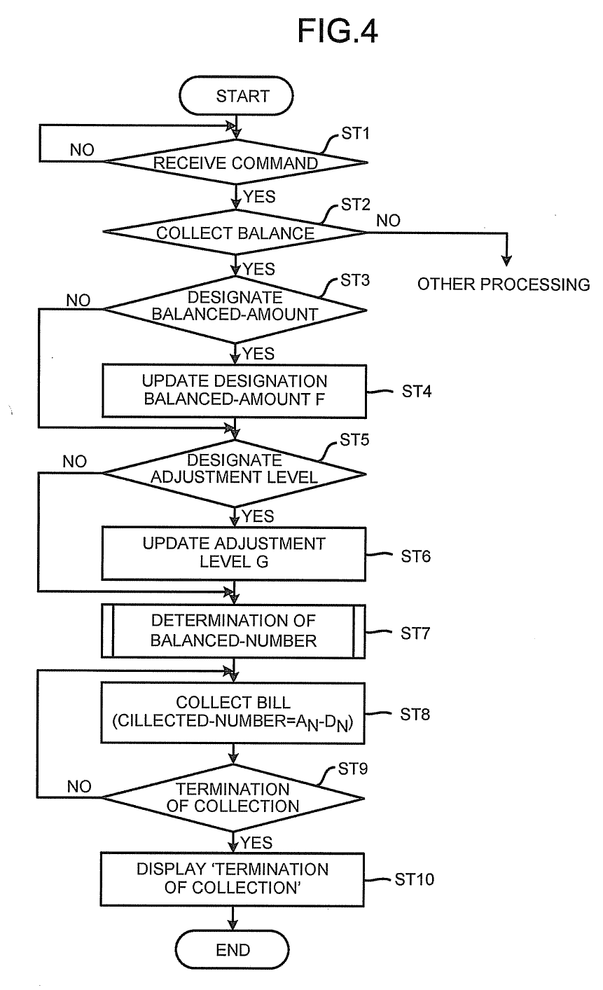

After receiving the balance and collecting instruction with the communication interface 35, the control unit 33 carries out the processing the sequence of which is shown in FIG. 4 according to the money collecting program stored in the storage unit 34.

First, the control unit 33 waits for an instruction sent from the POS terminal (ST1). After receiving an instruction through the communication interface 33, the control unit 33 determines whether or not the instruction is a balance and collecting instruction (ST2). If the instruction is not a balance and collecting instruction (ST2: No), the control unit 33 carries out a processing corresponding to the instruction. For example, if the instruction is a change dispensing instruction, the control unit 33 carries out a change dispensing processing.

If the instruction is a balance and collecting instruction (ST2: Yes), the control unit 33 determines whether or not a balance amount is contained in the instruction (ST3). If a balance amount is contained in the instruction (ST3: Yes), the control unit 33 changes the data in the designation balance amount storage 44 to the balance amount contained in the instruction (ST4). If no balance amount is contained in the instruction (ST3: No), the control unit 33 makes, no change on the data F in the designation balance amount storage 44.

Next, the control unit determines whether or not an adjustment grade is contained in the instruction (ST5). If an adjustment grade is contained in the instruction (ST5: Yes), the control unit 33 changes the data in the designation balance amount storage 45 to the adjustment grade contained in the instruction (ST6). If no adjustment grade is contained in the instruction (ST5: No), the control unit 33 makes no change on the data G in the adjustment grade storage 45.

Then, the control unit 33 carries out the following balance numbers determination processing to determine the numbers D1, D2, D3 of bills of different par values (ST7). If the balance numbers D1, D2 and D3 are determined, then the control unit 33 subtracts the balance numbers D1, D2 and D3 from the storing numbers A1, A2 and A3 of the bills of different par values stored in the bill storing repository 31, takes the resulting numbers as collecting numbers, and sends a collecting instruction indicative of the collecting numbers (A1-D1, A2-D2, A3-D3) to the carry-out processing section 39. After receiving the instruction, the carry-out processing section 39 outputs corresponding numbers of bills of each par value from the bill storing repository 31 to the bill collecting repository 32.

The control unit 33 waits for the completion of a bill collecting processing (ST9). After receiving a collecting completion response instruction from the carry-out processing section 39 (ST9: Yes), the control unit 33 displays a message ‘complete collecting’ on the display of the operating panel 4 (ST10).

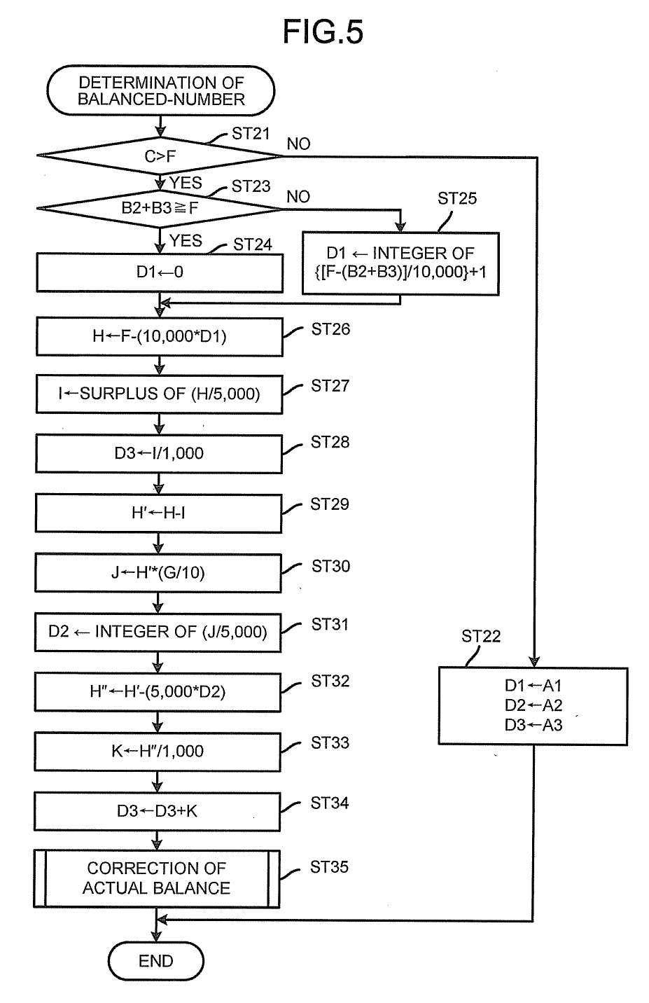

Then, the bill collecting processing is ended. FIG. 5 is a flow chart showing the specific flow of the balance number determination processing carried out in the Act ST7. After entering into a balance number determination processing, the control unit 33 first compares the stored balance C with the designation balance amount F (ST21). If the stored balance C is less than the designation balance amount F (ST21: No), then no bills are collected from the bill storing repository 31. In this case, the control unit 33 makes the par value-based balance numbers D1, D2 and D3 stored in the balance data table 43 in accord with the storing numbers A1, A2 and A3 of bills of corresponding par values stored in the storing data table 41. Moreover, the control unit 33 recalculates the par value-based balance amounts E1, E2 and E3 stored in the balance data table 43 (ST22). Then, the balance number determination processing is complete. Therefore, in this case, as the number of the numbers of bills of each par value to be collected in the acts following ST8 becomes 0, no bills are collected from the bill storing repository 31.

If it is determined in ST21 that the stored balance C is above the designation balance amount F, the control unit 33 compares the sum of the storing amount B3 of 1000-yen bills and the storing amount B2 of 5000-yen bills with the designation balance amount F (ST23). If the result is that the sum of B2 and B3 is above the designation balance amount F (ST23: Yes), then the designation balance amount F can be supplemented with 1000-yen bills and 5000-yen bills and 10000-yen bills can be totally collected. That is, there is no need to reserve 10000-yen bills in the bill storing repository 31, the control unit 33 therefore sets the balance number D1 of 10000-yen bills stored in the balance data table 43 to be 0 (ST24).

On the other hand, if the sum of B2 and B3 is less than the designation balance amount F (ST23: No), then 10000-yen bills should be supplied to make up the balance. Therefore, the control unit 33 divides the difference of the designation balance amount F and the sum of B2 and B3 by 10000 (that is, the par value of 10000-yen bill), adds 1 to the resulting quotient, and sets the integer part of the resulting value to be the balance number D1 of 10000-yen bills stored in the balance data table 43 (ST25).

Then, the control unit 33 subtracts the amounts of the numbers D1 of the reserved 10000-yen bills (10000*D1) from the balance amount F to calculate the residual balance amount H (ST26). The control unit 33 divides the residual balance amount H by 5000 (that is, the par value of 5000-yen bill) to obtain the remainder of the resulting quotient, that is, an fraction amount I less than the par value ‘5000’ (ST27). Then, the control unit 33 divides the fraction amount I by 1000 (that is, the par value of 1000-yen bill) to calculate the number of the numbers of 1000-yen bills equivalent to the fraction amount, and sets the calculated number as the balance number D3 stored in the balance data table 43 (ST28).

Next, the control unit 33 subtracts the fraction amount I from the residual balance amount H (ST29). Then, the control unit 33 multiplies the residual balance amount H′ resulting from the subtraction by an adjustment grade G 1/10 to obtain a product J (ST30). The product J is an amount equivalent to the ratio G of the 5000-yen bills and 1000-yen bills reserved in the residual balance amount H as a reserved change fund. The control unit 33 divides the product J by 5000 (that is, the par value of 5000-yen bill), and sets the integer part of the resulting quotient as the balance number D2 of 5000-yen bills stored in the balance data table 43 (ST31).

Next, the control unit 33 subtracts the total amount (5000*D2) of the reserved numbers D2 of 5000-yen bills from the residual balance amount H (ST32). Then, the control unit 33 divides the residual balance amount H″ resulting from the subtraction by 1000 (that is, the par value of 1000-yen bill) to obtain a quotient K (ST33). The control unit 33 adds the quotient K to the balance number D1 of 1000-yen bills stored in the balance data table 43 (ST34).

Then, the control unit 33 carries out an actual balance correction processing (ST35). The actual balance correction processing is to correct the balance numbers D2 and D3 of 5000-yen bills and 1000-yen bills if the balance number D2 of 5000-yen bills determined in ST31 and the balance number D3 of 1000-yen bills determined in ST34 are not actually stored in the bill storing repository 31.

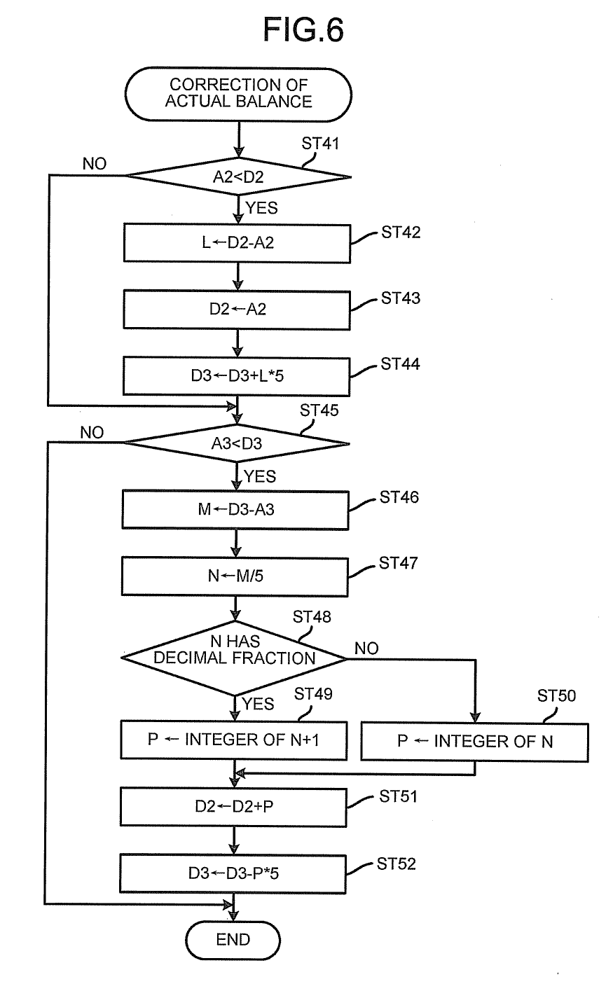

FIG. 6 is a flow chart showing the flow of a actual-balance correction processing. After entering into the actual-balance correction processing, the control unit 33 first compares the storing number A2 and the balance number D2 of 5000-yen bills (ST41). If the result of the comparison is that the storing number A2 is above the balance number D2 (ST41: No), then the flow turns to Act ST45.

On the other hand, if the result of the comparison is that the storing number A2 is less than the balance number D2 (ST41: Yes), then the control unit 33 subtracts the storing number A2 from the balance number D2 to obtain a difference L (ST42). Then, the control unit 33 changes the balance number D2 of 5000-yen bills stored in the balance data table 43 to the storing number A2 (ST43). Moreover, the control unit 33 multiplies the difference L by 5 to calculate the number (L*5) of the 1000-yen bills needed to make up the balance equal to the total amount of the numbers L of 5000-yen bills. Then, the number (L*5) is added to the balance number D3 of 1000-yen bills stored in the balance data table 43 to correct the balance number D3 (ST44). Then, the flow turns to Act ST45.

In the flow turns to Act ST45, the control unit 33 compares the storing number A3 and the balance number D3 of 1000-yen bills. The actual-balance correction processing is ended if the result of the comparison is that the storing number A3 is above the balance number D3 (ST41: No)

On the other hand, if the result of the comparison is that the storing number A3 is less than the balance number D3 (ST45: Yes), then the control unit 33 subtracts the storing number A3 from the balance number D3 to obtain a difference M (ST46). The control unit 33 divides the difference M by 5 (ST47). The control unit 33 further determines whether or not the quotient N has a fraction part (ST48). If the quotient N has a fraction part (ST48: Yes), then the control unit 33 adds 1 to the integer part of the quotient to obtain a sum P (ST49). If the quotient N has no fraction part (ST48: No), then the control unit 33 sets the integer part of the quotient N to be the value P, without adding 1 to the integer part of the quotient (ST50). In such a manner, the value obtained in ST49 or ST50 becomes the minimum number of the 5000-yen bills needed to maintain the amount of M numbers of 1000-yen bills.

Then, the control unit 33 modifies the balance number D2 by adding the minimum number P to the balance number D2 of 5000-yen bills stored in the balance data table 43 (ST51). Moreover, the control unit 33 modifies the balance number D3 by subtracting the product of the minimum number P and 5 from the balance number D3 of 1000-yen bills stored in the balance data table 43 (ST52). Then, the control unit 33 ends the actual-balance correction processing.

The balance number determination processing is ended with the end of the actual-balance correction processing.

Here, the processing carried out in ST23, ST24 and ST25 in the balance number determination processing constitutes a seventh unit which determines the balance number D1 of 10000-yen bills (the third bill having the maximum par value) according to the total amount B2+B3 of 1000-yen bills and 5000-yen bills and a designation balance amount F.

Acts ST27 and ST28 of the balance number determination processing constitute a first unit which calculates the fraction amount I of the designation balance amount F less than the par value ‘5000’ of 5000-yen bill (the second bill), and calculates the number D3 of the 1000-yen bills (the first bill) equivalent to the fraction amount I.

Acts ST29-ST33 of the balance number determination processing constitute a second unit which subtracts the amount of D1 numbers of 10000-yen bills determined by the seventh unit and the amount of D3 numbers of 1000-yen bills determined by the first unit from the designation balance amount F to calculate the numbers K and D of the 1000-yen bills and 5000-yen bills that are needed to supplement the residual balance amount H′ in the ratio specified by an adjustment grade G.

Act ST34 of the balance number determination processing constitutes a third unit which adds the number D3 calculated by the first unit to the number K of 1000-yen bills calculated by the second unit and takes the sum as the balance number D3 of 1000-yen bills. Act ST31 of the balance number determination processing constitutes a fourth unit which determines the number D2 of 5000-yen bills calculated by the second unit as the balance number D2 of 5000-yen bills.

Acts ST41-ST44 of the actual-balance correction processing constitute a fifth unit which modifies, when the actual storing number A2, of the 5000-yen bills stored in the bill storing repository 31 is less than the balance number D2 of 5000-yen bills determined by the fourth unit, the balance number D2 to the actual storing number A2, calculates the number (L*5) of the 1000-yen bills equivalent to the amount of (D2−A2) numbers of 5000-yen bills, and adds the number (L*5) to the balance number D3 of 1000-yen bills determined by the third unit.

Acts ST45-ST52 of the actual-balance correction processing constitute a sixth unit which calculates, when the actual storing number A3 of the 1000-yen bills stored in the bill storing repository 31 is less than the balance number D3 of 1000-yen bills determined by the third unit, the minimum number P of the 5000-yen bills needed to supplement the amount of M (M=D3−A3) numbers of 1000-yen bills, adds the minimum number P to the balance number D2 of 5000-yen bills determined by the fourth unit, and subtracts the numbers of 1000-yen bills equivalent in amount to the P numbers of 5000-yen bills from the balance number D3 of 1000-yen bills determined by the third unit.

### First Embodiment

The storing number A1 of 10000-yen bills is 10, the storing number A2 of 5000-yen bills is 20, the storing number A3 of 1000-yen bills is 70, and the received a collecting balance instruction that a designation balance amount F is 123000-yen and an adjustment grade G is 4.

In this case, as the stored balance C(=270000) is above the designation balance amount F, the sum (B2+B3) of the amount B2(=100000) of A2 numbers of stored 5000-yen bills and the amount B3(=70000) of A3 numbers of stored 1000-yen bills is compared with the designation balance amount F. As the result of the comparison is that the sum (B2+B3) is above the designation balance amount F, the balance number of 10000-yen bills is set to be 0. Therefore, the residual balance amount H is equal to the designation balance amount F(=123000).

Then, the fraction amount I of the residual balance amount H(=123000) less than the unit of the par value 5000 is calculated to be 3000, and the number D3 of the 1000-yen bills equivalent to the fraction amount I(=3000) is calculated.

Next, the fraction amount I(=3000) is subtracted from the residual balance amount H(=123000). Then, calculates the number D2 of 1000-yen bill and the number K of 5000-yen bill needed to fill the residual balance amount H′(=120000) that is the result of subtracting the fraction amount I from the residual balance amount H, according to the ratio of 1000-yen bill to 5000-yen bill is 6:4 specified by the adjustment grade G. Thus, the balance number D2 of 5000-yen bill is determined as 9, and the balance number D3 of 1000-yen bill is determined as 78.

Here, the balance number D2(=9) of 5000-yen bills is less than the storing number A2(=20), and the balance number D3(=78) of 1000-yen bills is above the storing number A3(=75). That is, the storing number A3 of 1000-yen bills is less than the balance number D3 of the bills of the same par value. Therefore, the following actual-balance correction processing is carried out: first, subtract the storing number A3 from the balance number D3 to obtain a difference M(=3), then, the difference M is divided by 5, as the resulting quotient is 0.6, that is, the resulting quotient has a fraction part, 1 is added to the integer part of the resulting quotient to calculate a value N(=1), and last, correct the balance number D2 of 5000-yen bills be 10 and the balance number D3 of 1000-yen bills to be 73.

Thus, 10 numbers of 10000-yen bills, 10 numbers of 5000-yen bills and 2 numbers of 1000-yen bills are collected to the bill collecting repository 32 from the bill storing repository 31. As a result, 10 numbers of 5000-yen bills and 73 numbers of 1000-yen bills are reserved in the bill storing repository 31, that is, the reserved change fund is 123000 yen.

### Second Embodiment

In the second embodiment, the adjustment grade G is changed from 4 in the first embodiment to 6.

In this case, the process from the determination of the balance number D1 of 10000-yen bills being 0 to the subtraction the fraction amount I(=3000) from the residual balance amount H(=123000) is equivalent to the first embodiment. In the second embodiment, calculates each numbers of 1000-yen bill and 5000-yen bill needed to fill the residual balance amount H′(=120000) that is the result of subtracting the fraction amount I from the residual balance amount H, according to the ratio of 1000-yen bill to 5000-yen bill is 4:6 specified by the adjustment grade G. Thus, the balance number D2 of 5000-yen bill is determined as 14, and the balance number D3 of 1000-yen bill is determined as 53.

Here, the balance number D2(=14) of 5000-yen bills is less than the storing number A2(=20), and the balance number D3(=53) of 1000-yen bills is also less than the storing number A3(=75). Thus, 10 numbers of 10000-yen bills, 6 numbers of 5000-yen bills and 22 numbers of 1000-yen bills are collected to the bill collecting repository 32 from the bill storing repository 31. As a result, 14 numbers of 5000-yen bills and 53 numbers of 1000-yen bills are reserved in the bill storing repository 31, that is, the reserved change fund is 123000 yen.

### Third Embodiment

The designation balance amount F is changed from 123000-yen in first embodiment to 185000-yen.

In this case, as the sum (B2+B3) of the amount B2(=100,000) of A2 numbers of stored 5000-yen bills and the amount B3(=70,000) of A3 numbers of stored 1000-yen bills is less than the designation balance amount F, the minimal number 2 of the 10000-yen bills needed to make up the balance is calculated to be 2, and the balance number D1 of 10000-yen bills is therefore determined.

Next, the fraction amount I of the residual balance amount H(=165000) which is calculated by subtracting the amount of the 10000-yen bills from the designation balance amount F, less than the unit of the par value ‘5000’ is calculated. However, as the fraction amount I is 0, the number D3 of 1000-yen bills is 0 at this time.

Then, calculates the number D2(=13) of 1000-yen bill and the number K(=100) of 5000-yen bill needed to fill the residual balance amount H′(=165000) according to the ratio of 1000-yen bill to 5000-yen bill is 6:4 specified by the adjustment grade G. Thus, the balance number D2 of 5000-yen bill is determined as 13, and the balance number D3 of 1000-yen bill is determined as 100.

In this case, as the storing number A3 of 1000-yen bills is less than the balance number D3 of the bills of the same par value, the following actual-balance correction processing is carried out: first, subtract the storing number A3 from the balance number D3 to obtain a difference M(=30), then, the difference M is divided by 5, as the resulting quotient is 6.0, that is, the resulting quotient has no fraction part, the integer part is 6 of the resulting quotient is not added 1, and last, correct the balance number D2 of 5000-yen bills to be 19 and the balance number D3 of 1000-yen bills to be 70.

Thus, 8 numbers of 10000-yen bills, 1 number of 5000-yen bills and 32 numbers of 1000-yen bills are collected to the bill collecting repository 32 from the bill storing repository 31. As a result, 2 numbers of 10000-yen bills, 19 numbers of 5000-yen bills and 70 numbers of 1000-yen bills are kept in the bill storing repository 31, that is, the reserved change fund is changed to 185000 yen.

In this way, according to this embodiment, in the bill change dispenser 1, just designate a designation balance amount F and an adjustment grade G freely, may take the ratio of each denomination of the amount and number of bills as a reserved change fund for reserve as desired ratio.

Other embodiment of the change dispenser is described below.

For example, the adjustment grade G represents the ratio of 5000-yen bills to 1000-yen bills reserved as a change fund in above embodiments described herein, however, the adjustment grade G may also represent the ratio of 1000-yen bills to 5000-yen bills. In this case, in the act ST30 shown in FIG. 5, the adjustment grade G is replaced by ‘10-G’ to calculate the amount J.

Moreover, Acts ST45-ST52 may be carried out before Acts ST41-ST44 during the actual-balance correction processing.

Moreover, in above embodiments described herein, it is described the application of a bill change dispenser 1 for processing three kinds of bills, that is: the minimal par value: 1000-yen bills (a first bill), the maximum par value: 10000-yen bills (a third bill) and the intermediate par value: 5000-yen bills (a second bill). However, the present invention is not limited to this. For example, a bill change dispenser may also be applied which stores the 5000-yen bills and 1000-yen bills to be dispensed as change in a bill storing repository 31 and collects 10000-yen bills in a bill collecting repository 32.

In this case, the Acts ST21-ST26 shown in FIG. 5 can be omitted. That is, the second unit made up of Acts ST29-ST33 of the balance number determination processing calculates the numbers K and D2 of the 1000-yen bills and 5000-yen bills that are needed to supplement the residual balance amount H′ resulting from a subtraction of the amount of D3 numbers of 1000-yen bills determined by the first unit from the designation balance amount F in the ratio specified by an adjustment grade G.

Moreover, the present invention is also applicable to a coin change dispenser but not limited to a bill change dispenser.

Further, in above embodiments described herein, a money collecting program for achieving the functions of the bill change dispenser is preinstalled in the storage unit 34 configured in the bill change dispenser. However, the present invention is not limited to this, the same program can also be downloaded to the bill change dispenser from a network. Or the same program recorded in a recording medium can also be installed in the bill change dispenser. The form of the recording medium is not limited as long as the recording medium can store programs like a CD-ROM or a memory card and is readable to a device. Further, the function achieved by an installed or downloaded program can also be achieved through the cooperation with an OS (Operating System) in the device.

While certain embodiments have been described, these embodiments have been presented by way of example only, and are not intended to limit the scope of the inventions. Indeed, the novel method or system described herein may be embodied in a variety of other forms. Furthermore, various omissions, substitutions and changes in the form of the novel method or system described herein may be made without departing from the spirit of the invention. The accompanying claims are intended to cover such embodiments or variations thereof as would fall within the scope and spirit of the invention.

What is claimed is:

1. A change dispenser, comprising:
a money collecting unit configured to balance a given balance amount of money as a reserved change fund in a money storing unit in which a first money having the minimum par value and a second money greater in par value than the first money are stored and to collect the rest money from the money storing unit, wherein
the money collecting unit comprises:
a first unit configured to, for the balance amount, calculate the fraction amount less than unit of the par value of the second money and the number of the first money equivalent to the fraction amount;
a second unit configured to calculate each numbers of the first money and second money needed to fill a balance amount obtained by subtracting the amount of the first money based on the number calculated by the first unit from the balance amount, according to the first money and the second money at a given ratio;
a third unit configured to determine the balance number of the first moneys by adding the number of the first money calculated by the second unit to the number of the first money calculated by the first unit; and
a fourth unit configured to determine the number of the second money calculated by the second unit as the balance number of the second money.

2. The change dispenser according to claim 1, further comprising:
a fifth unit configured to change the balance number of the second money to a actual-stored number of the second money, calculate the amount of the first money equal to the amount of the second money of the amount obtained by subtracting the actual-stored number of the second money from the balance amount of the second money and add the amount calculated to the balance number of the first money determined by the third unit, if the actual-stored number of the second money stored in the money storing unit less than the balance number of the second money determined by the fourth unit.

3. The change dispenser according to claim 1, further comprising:
a sixth unit configured to calculate the minimum number of the second money needed to fill the amount of the first money based on the number obtained by subtracting the actual-stored amount of the first money from the balance amount of the first money, add the minimum number to the balance number of the second money determined by fourth unit and subtract the number of first money equal to the amount of the second money of the minimum number from the balance number of the first money, if the actual-stored number of the first money stored in the money storing unit less than the balance number of the first money determined by the third unit.

4. The change dispenser according to claims 1, wherein
the money storing unit configured to store the third money that whose par value is the maximum value; and
the money collecting unit comprises:
a seventh unit configured to determine the balance number of the second money according to the total amount obtained by adding the first money to the second money stored in the money storing unit and the balance amount, wherein
the second unit configured to calculate each numbers of the first money and second money needed to fill a balance amount obtained by subtracting the amount of the first money of the balance number determined by the seventh unit and the amount of the first money of the number calculated by the first unit from the balance amount, according to the first money and the second money at a given ratio.

5. A money collecting method, in a money storing unit in which a first money having the minimum par value and a second money greater in par value than the first money are stored, for leaving a given balance amount of money as a reserved change fund in the money storing unit and collecting the rest moneys from the money storing unit, comprising:
calculating the fraction amount less than unit of the par value of the second money for the balance amount and the number of the first money equivalent to the fraction amount;
calculating each numbers of the first money and second money needed to fill a balance amount obtained by subtracting the amount of the first money based on the number calculated from the balance amount, according to the first money and the second money at a given ratio;
determining the balance number of the first moneys by adding the number of the first money calculated to the number of the first money calculated; and
determining the number of the second money calculated as the balance number of the second money.
